(19) United States
(12) Patent Application Publication
(10) Pub. No.: US 2013/0067782 A1
(43) Pub. Date: Mar. 21, 2013

(54) Traffic Signs Optimized for Night Vision Based Navigation

(71) Applicants: John Michael Hoffer, Bel Air, MD (US); Cunwu Yang, Newark, DE (US); Sean Xiaolu Wang, Wilmington, DE (US)

(72) Inventors: John Michael Hoffer, Bel Air, MD (US); Cunwu Yang, Newark, DE (US); Sean Xiaolu Wang, Wilmington, DE (US)

(73) Assignee: BWT PROPERTY, INC., Newark, DE (US)

(21) Appl. No.: 13/612,946

(22) Filed: Sep. 13, 2012

Related U.S. Application Data
(60) Provisional application No. 61/535,465, filed on Sep. 16, 2011.

(51) Int. Cl. G09F 13/16

(52) U.S. Cl. 40/582

(57) ABSTRACT

This invention relates to traffic signs which are optimized for night vision based navigation. The symbol/word of the traffic sign is designed to have a thick outline with different reflectivity relative to the background in the infrared wavelength region. As a result, the traffic signs are not only visible to the human eyes but also discernible under night vision equipment.

### REFERENCE TO RELATED APPLICATION

This application claims an invention which was disclosed in Provisional Patent Application No. 61/535,465, filed Sep. 16, 2011, entitled “TRAFFIC SIGNS OPTIMIZED FOR NIGHT VISION PURPOSES”. The benefit under 35 USC §119(e) of the above mentioned United States Provisional Applications is hereby claimed, and the aforementioned applications are hereby incorporated herein by reference.

### FIELD OF THE INVENTION

This invention generally relates to traffic signs and more specifically to traffic signs optimized for night vision based navigation.

### BACKGROUND

Traditional traffic signs on roads, airports, or seaways use symbols or words to provide information to drivers, pilots, or mariners. These traffic signs can become completely indiscernible for users of night vision equipment, e.g. night vision goggles (NVGs) or forward looking infrared (FLIR) equipment due to the fact that the symbol/word of the sign may have similar reflectivity as the background in the infrared wavelength region. This poses a hurdle for certain navigational needs involving night vision equipment under low light conditions.

There thus exists a need for traffic signs with enhanced visibility under night vision equipment.

### SUMMARY OF THE INVENTION

It is thus the overall goal of the present invention to provide traffic signs which are optimized for night vision based navigation. The symbol/word of the traffic sign is designed to have a thick outline with different reflectivity relative to the background in the infrared wavelength region. As a result, the traffic signs are not only visible to the human eyes but also discernible under night vision equipment.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates one exemplary traffic sign designed for night vision based navigation;

FIG. 2 shows a stop sign under infrared illumination, of which the characters ‘S’, ‘O’, and ‘P’ follow traditional designs with white letter on a red background, while the character ‘T’ is designed with a thick infrared-visible outline for night vision based navigation.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to traffic signs optimized for night vision based navigation. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

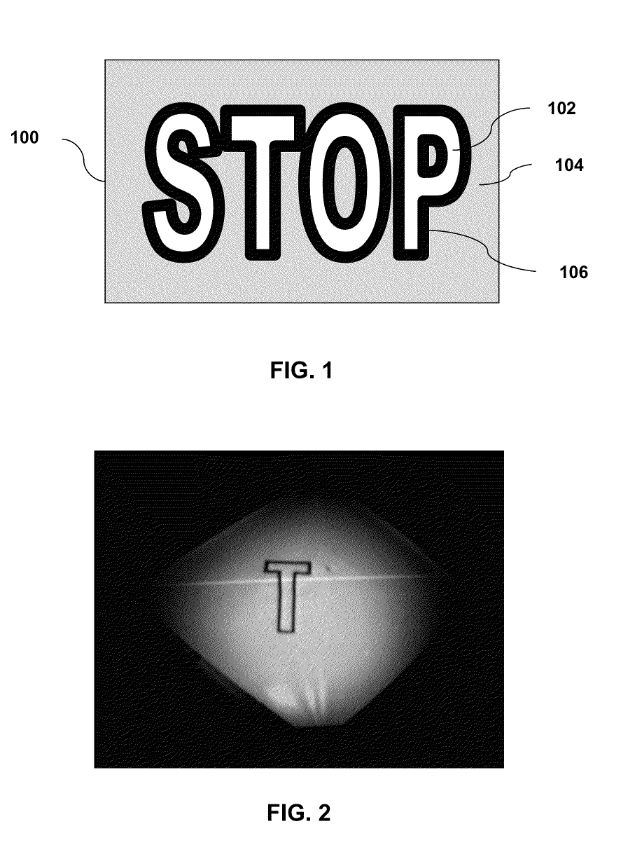

One exemplary embodiment of the present invention is illustrated in FIG. 1. The traffic sign 100 is a modified airport runway hold sign with four white letters 102 (‘S’, ‘T’, ‘O’, and ‘P’) on a red background 104. Unlike traditional runway hold signs, the four white letters 102 of the traffic sign 100 are encircled by thick infrared-visible outlines 106, which have different reflectivity than does the red background 104 under both visible and infrared light illumination. The reflectivity difference between the outlines 106 and the red background 104 ensures the traffic sign 100 to be visible not only to human eyes but also under night vision equipment. The width of the infrared-visible outlines 106 is designed to be comparable to the width of the white letters 102 to enhance their visibility.

For demonstration purposes, FIG. 2 show a stop sign under infrared illumination, of which the characters ‘S’, ‘O’, and ‘P’ follow traditional designs with white letters on a red background, while the character ‘T’ is encircled with a thick infrared-visible outline. When the stop sign is viewed under an infrared camera, the letters S’, ‘O’, and ‘P’ become completely indiscernible because the reflectivity of the white letter is similar to that of the red background in the infrared wavelength region. In comparison, the letter ‘T’ is clearly visible due to the reflectivity difference of its thick infrared-visible outline.

In a slight variation of the present embodiment, the outline of the letter has similar reflectivity and color perception as the background or the letter does in the visible wavelength region yet has different reflectivity in the infrared wavelength region. This makes the outline invisible to human eyes but visible to users of night vision equipment for assisting night vision based navigation under low light level conditions.

In yet another variation of the present embodiment, the symbol/word of the traffic sign is made to have different reflectivity with regards to the background in the infrared wavelength region. Thus the outline in the above disclosed exemplary embodiment can be omitted. It is also possible to make the symbol/word and the background of the sign to have similar reflectivity in the visible wavelength region, but to have different reflectivity in the infrared wavelength region such that the sign is only visible to users of night vision equipment. Still further, the traffic sign may have two set of symbols/words. One set of symbol/word is visible to human eyes, while the other set of symbol/word is only visible under night vision equipment. Such kind of traffic signs can be used for covert navigation purposes.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A traffic sign for night vision based navigation, the traffic sign comprising:
at least one symbol or word encircled by an outline; and
at least one background;
wherein said outline has different reflectivity relative to said at least one background in an infrared wavelength region.

2. The traffic sign of claim 1, wherein said outline has a width comparable to a width of said at least one symbol or word.

3. The traffic sign of claim 1, wherein said outline has similar reflectivity and color perception as said at least one background or said at least one symbol or word does in a visible wavelength region.
